(19) United States
(12) Patent Application Publication
(10) Pub. No.: US 2007/0239444 A1
(43) Pub. Date: Oct. 11, 2007

(54) VOICE SIGNAL PERTURBATION FOR SPEECH RECOGNITION

(75) Inventor: Changxue C. Ma, Barrington, IL (US)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/277,793

(22) Filed: Mar. 29, 2006

(51) Int. Cl. G10L 15/20

(52) U.S. Cl. 704/233

(57) ABSTRACT

A system (100) and method (200) for generating a perturbed phonetic string for use in speech recognition. The method can include generating (202) a feature vector set from a spoken utterance, applying (204) a perturbation to the feature vector set for producing a perturbed feature vector set, and phonetically decoding (206) the perturbed feature vector set for producing a perturbed phonetic string. The perturbation mimics environmental variability and speaker variability for reducing the number of spoken utterances in speech recognition applications.

### FIELD OF THE INVENTION

The embodiments herein relate generally to speech processing and more particularly to speech recognition systems.

### BACKGROUND

The use of portable electronic devices and mobile communication devices has increased dramatically in recent years. Mobile communication devices are offering more features such as speech recognition, voice identification, and bio-metrics. Such features are facilitating the ease by which humans can interact with mobile devices. In particular, the communication interface between humans and mobile devices becomes more natural as the mobile devices attempt to learn from their environment and the people within the environment.

Speech recognition systems available on mobile devices have learned to recognize human speech, including many vocabulary words to associate spoken commands with specific actions. For example, a mobile device can store spoken voice tags that associate a phone number with a caller. A user of the mobile device can speak the voice tag to the mobile device which the mobile device can recognize from a vocabulary of voice tags to automatically dial the number.

Speech recognition systems have evolved from speaker-dependent systems to speaker-independent systems. A speaker-dependent system is one which is particular to a user's voice. It can be specifically trained on spoken examples provided by that person's voice. A speaker-dependent system is trained to learn the characteristics and the manner in which that person speaks. In contrast, a speaker-independent system is trained on spoken examples provided by a plurality of people. A speaker-independent system learns to generalize words and meaning from the multitude of spoken examples provided by the group of people.

A user of a mobile device is generally the person most often using the speech recognition capabilities of the mobile device. Accordingly, the speech recognition performance can be improved when multiple representations of that person's voice are provided during training. The same can be the case when the speech recognition system is used for actual recognition tasks. In general, repetitive spoken utterances, such as voice tags, are presented to a speech recognition system for improving recognition accuracy. The system learns to form and evaluate associations from the spoken utterances for identifying words during the recognition. Adequate performance generally involves the presentation of multiple voice tags to the speech recognition system. However, some speaker-independent systems may already be fully trained, and cannot be further retrained to emphasize use to a particular person's voice. For example, in a mobile device, a speaker-independent system may already be stored in memory for which further training is not feasible. And, a speaker-dependent system may require numerous voice tag examples which can be an annoying request to the user. A user may become tired of repeating words or sentences for training or testing the speaker-dependent recognition system.

### SUMMARY

The embodiments of the invention concern a method and system for producing phonetic voice tag variants for use in speech recognition. The method can include generating a feature vector from a spoken utterance, generating a first phonetic voice tag from the feature vector, applying one or more perturbations to the feature vector for producing one or more perturbed feature vectors, converting the perturbed feature vectors into one or more phonetic voice tag variants, and recognizing the spoken utterance from the one or more phonetic voice tag variants and the first phonetic voice tag. The method can generate multiple voice tags through a perturbation applied during voice-to-phoneme conversion. Embodiments herein can improve voice recognition performance for either a speaker-dependent or speaker-independent system using fewer voice tags and/or without retraining.

Embodiments of the invention also concern a method for generating a perturbed phonetic string for use in speech recognition. The method can include generating a feature vector set from a first voice tag, applying a perturbation to the feature vector set for producing a perturbed feature vector set, phonetically decoding the perturbed feature vector set for producing a perturbed phonetic string. The phonetic decoding converts a perturbed feature vector into a phonetic string, wherein a phonetic string represents a sequence of symbolic characters representing phonemes of speech. The perturbation can include adding randomly distributed noise to the feature vector set, multiplying the randomly distributed noise by a variance, and multiplying the variance by a scaling factor. In one aspect, the variance can be a variance of the feature vector set. In another aspect, the variance can be an acoustical variability of an environmental condition. The scaling factor can be selected to correspond to the environmental condition during a recognition of the voice tag. The variance can also correspond to a variability of a speaker producing the spoken utterance. In one arrangement, the features of the feature vector can be Mel Frequency Cepstral Coefficients, and the phonetic decoder can include a plurality of trained speaker-independent Hidden Markov Models.

Embodiments of the invention also concern a system for generating a perturbed phonetic string for use in speech recognition. The system can include a feature extractor for generating a feature vector set from a first voice tag, a processor for applying a perturbation to said feature vector set for producing a perturbed feature vector set, a phonetic decoder for converting the perturbed feature vector set into a perturbed phonetic string. The phonetic string can be a sequence of symbolic characters representing phonemes of speech. The processor can add randomly distributed noise to the feature vector set, multiply the randomly distributed noise by a variance, and multiply the variance by a scaling factor. In one aspect, the variance can be a variance of the feature vector set. In another aspect, the variance can be an acoustical variability of an environmental condition. The scaling factor can be selected to correspond to an environmental condition during a recognition of the first voice tag. In yet another aspect, the variance can correspond to a variability of a speaker producing the spoken utterance.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 illustrates a system for generating a perturbed phonetic string in accordance with an embodiment of the inventive arrangements;

FIG. 2 presents a method for generating a perturbed phonetic string in accordance with an embodiment of the inventive arrangements;

FIG. 3 illustrates a flowchart for generating the perturbed phonetic string of FIG. 1 in accordance with an embodiment of the inventive arrangements; and

FIG. 4 presents a method for producing phonetic voice tag variants in voice-to-phoneme conversion in accordance with an embodiment of the inventive arrangements.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely. The term “processing” can be defined as number of suitable processors, controllers, units, or the like that carry out a pre-programmed or programmed set of instructions.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Embodiments of the invention concern a method and system for producing phonetic voice tag variants from a spoken utterance when performing speech recognition. In particular, a user is generally required to say more than one spoken utterance during training or testing. Providing more than one spoken utterance provides a more appropriate representation of the overall variability likely to be encountered during speech recognition. However, requesting a user to present many spoken utterances can be burdensome to the user. It is desirable therefore to generate several different phonetic voice tags from a single spoken utterance. Accordingly, phonetic voice tag variants can be generated from a single spoken utterance through a means of perturbation corresponding to a variance associated with presenting the spoken utterance multiple times. The variance can include the speaker's variance, such as the variance associated with the person's vocal characteristics, or it can include variance due to environmental conditions.

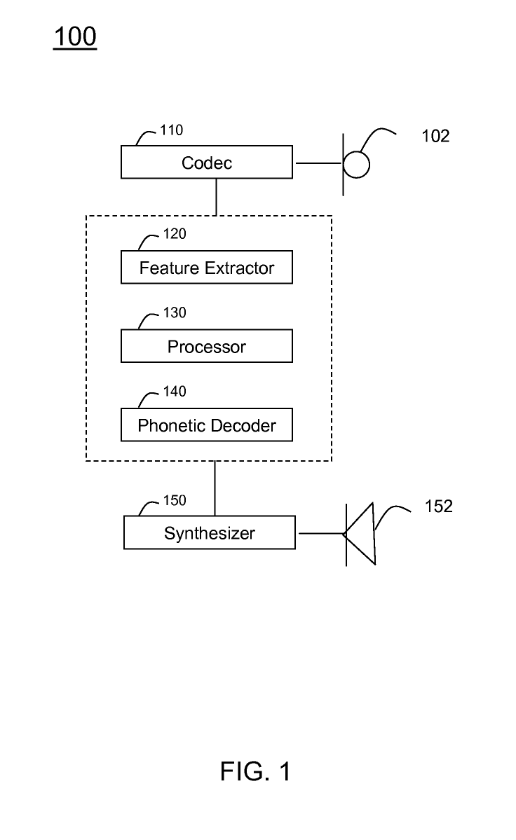

Referring to FIG. 1, a speech recognition system 100 is shown. The speech recognition system (SRS) 100 can reside on a processing platform such as a mobile communication device, a computer, a microprocessor, a DSP, a microchip, or any other system or device capable of computational processing. In one embodiment, the SRS 100 can be on a mobile device, where a user of the mobile device can communicate spoken voice dial commands to the mobile device which the mobile device can recognize. For example, the SRS 100 can recognize spoken utterances associated with a phone number and automatically dial the phone number. Embodiments of the invention are not herein limited to automatic number dialing. Those skilled in the art can appreciate that the SRS 100 can be applied to voice navigation, voice commands, VoIP, Voice XML, Voice Identification, Voice Bio-metrics, Voice dictation, and the like.

The SRS 100 can include a codec 110, a feature extractor 120, a processor 130, a phonetic decoder 140, and a synthesizer 150. The SRS 100 can also include a microphone 102 for acquiring acoustic speech signals, and a speaker 152 for playing recognized speech. Embodiments of the invention herein concern the feature extractor 120, processor 130, and phonetic decoder 140. The microphone 102, codec 110, synthesizer 150, and speaker 152 are presented herein for context and are not necessarily aspects of the embodiments.

In practice, acoustic signals can be captured from the microphone 102, which the codec 110 can convert to a digital speech signal (herein termed speech signal). The feature extractor 120 can extract salient features from the speech signal pertinent for speech recognition. For example, it is known that short time sections of speech can be represented as slowly varying time signals which can be modeled by a relatively stationary filter. In one aspect, the filter coefficients can be the features extracted by the feature extractor 120 and therein associated with the short time section of speech. Other features, such as statistical or parametric features, can also be used to model the speech signal. The feature extractor 120 can produce a feature vector from the features of the short-time frames of speech.

The processor 130 can apply a perturbation to the feature vector for varying the dynamics of the features. For example, the processor 130 can add random noise to the feature vector to artificially extend the numeric range of the features. The processor 130 can filter the feature vector for suppressing or amplifying particular features. In one arrangement, the processor 130 can generate a perturbed feature vector for each short-time frame of speech. A perturbed feature vector is a feature vector whose features have been intentionally adjusted to emphasize or deemphasize certain characteristics. For example, features can be perturbed in accordance with an environmental condition or in accordance with a person's vocal characteristics.

The phonetic decoder 140 can receive the feature vectors or the perturbed feature vectors and generate a phonetic string. A phonetic string contains a sequence of text based symbols representing the phonemes of speech. The phonetic decoder 140 can identify a feature vector as one of the phonemes of speech. Accordingly, a phonetic character of the phonetic string can represent a phoneme associated with a feature vector. A phoneme can also be the concatenation of one or more feature vectors. For example, a short phoneme may be one feature vector, whereas a long phoneme may consist of the concatenation of three feature vectors.

Phonology is the study of how sounds are produced. Letters, words, and sentences can all be represented as a phonetic string, which describes how the sounds are literally produced from the phonetic symbols. Accordingly, the phonetic string produced by the phonetic decoder 140 provides a textual representation of speech that can be interpreted by a Phonologist or a system capable of converting phonetic symbols to speech. In one example, the synthesizer 150 can convert the phonetic string into an acoustic speech signal. The synthesizer 150 can sequentially process the phonetic symbols of the phonetic string and generate artificial speech. Notably, embodiments of the invention are directed to a method and system for perturbing features of speech and not directly to methods of generating artificial speech. The speech synthesizer is 150 is disclosed within the context for identifying means by which a phonetic string can be converted to speech

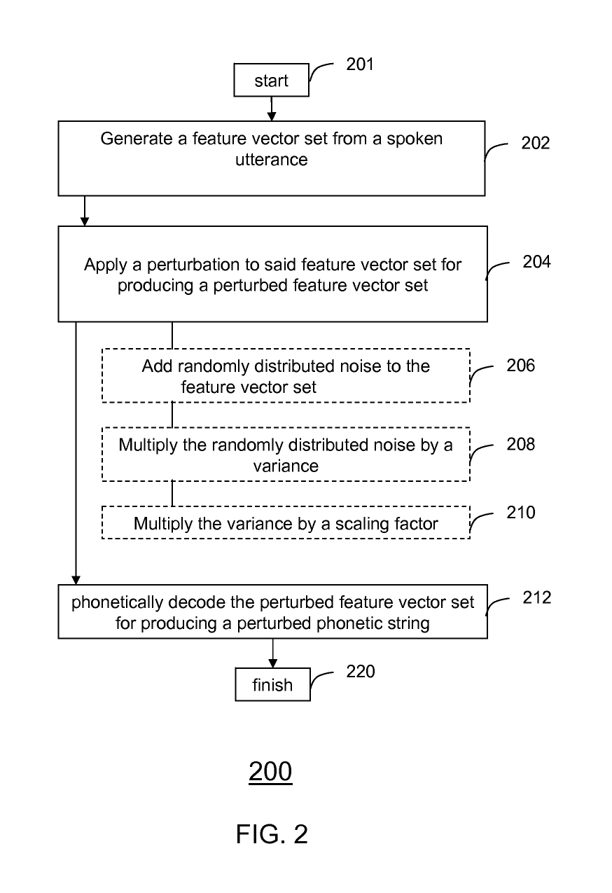

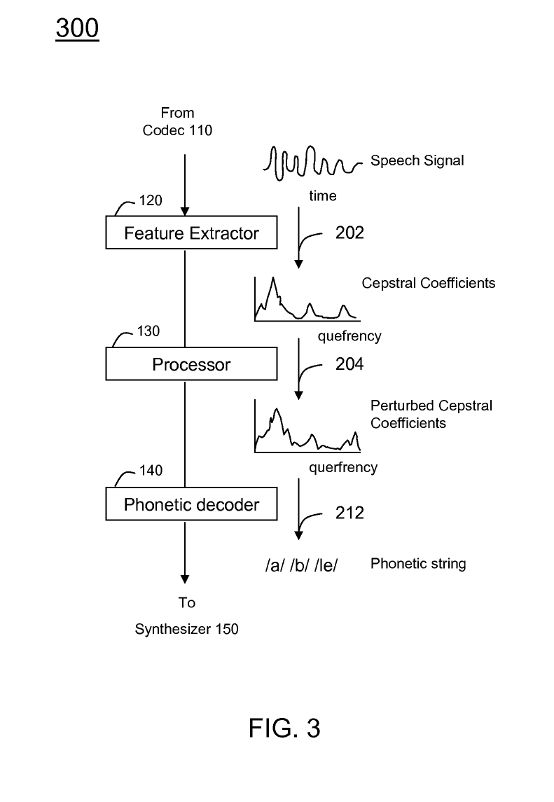

Referring to FIG. 2, a method 200 for perturbing a feature vector for use in speech recognition is shown. When describing the method 200, reference will be made to FIGS. 1 and 3, although it must be noted that the method 200 can be practiced in any other suitable system or device. FIG. 3 presents an illustration of the method 200 in conjunction with the structural elements of FIG. 1. FIG. 3 is useful for visualizing the outputs of the structural elements associated with the method steps. The steps of the method 200 are not limited to the particular order in which they are presented in FIG. 2. The inventive method can also have a greater number of steps or a fewer number of steps than those shown in FIG. 2.

At step 201, the method can start. The method can start in a state where an acoustic signal has been captured and converted to a speech signal. The acoustic signal can be a spoken utterance such as a voice tag which is can be commonly associated with a phone number. For example, referring to FIG. 3 the acoustic signal can be speech signal converted from acoustic form to digital form by the converter 110. The speech signal can be a time domain waveform such as PCM coded speech.

At step 202, a feature vector set can be generated from the speech signal. A feature vector set can be considered a compressed spectral representation of a short-time frame of speech. In practice, speech can be broken down into consecutive overlapping short-time frames generally between 20-25 ms in length with sampling frequencies between 8-44.1 KHz. Each short-time frame of speech can be represented by a feature vector. The feature vector can be a set of Linear Prediction Coefficients (LPC), Cepstral Coefficients, Mel-frequency Cepstral Coefficients, Fast Fourier Transform Coefficients (FFT), Log-Area Ratio (PARCOR) coefficients, or any other set of speech related coefficients though are not herein limited to these. Certain coefficient sets are more robust to noise, dynamic range, precision, and scaling. For example, referring to FIG. 3, a cepstral feature vector is shown. Notably, cepstral coefficients are known to be good candidates for speech recognition features. The lower index cepstral coefficients describe filter coefficients associated with the spectral envelope. Higher index cepstral coefficients represent the spectral fine structure such as the pitch which can be seen as a periodic component.

At step 204, a perturbation can be applied to the feature vector set for producing a perturbed feature vector set. For example a perturbation can be an intentionally applied change to the feature vector set that may emphasize or de-emphasize certain features. In one aspect, perturbation can change the dynamic range of the feature vector, and accordingly the variability. For example, referring to FIG. 3, the cepstral coefficients can be perturbed in the frequency domain. In practice, the cepstral coefficients can be perturbed in amplitude though the perturbation is not herein limited to amplitude only. Cepstral coefficients are statistically independent features having spectral distortion properties correlated to log spectral distances. Understandably, perturbation can include applying selective spectral distortion to certain features of a feature vector.

Speech recognition systems commonly require a person to present multiple variations of the same word or sentence. Multiple examples of a spoken utterance increase the variability for recognizing spoken utterances. The recognition performance improves with increased amounts of training data. Accordingly, the variability of the feature vector set can be increased to improve voice recognition performance. Variability increases the generalization capabilities of a speech recognition system for identifying speech. Increasing the variability of feature vectors mimics the variability of the repetitive process associated with presenting multiple spoken utterances.

Understandably, a person may speak the same word in a very different way and with very different pronunciations at different times and under different conditions. A person's pitch, inflection, accent, and annunciation may change significantly with the same word depending on the person's mood, physical state, or environment. A person when rested may pronounce a word differently than when active. Similarly, a person speaking in a quiet environment may pronounce speech differently that when speaking in a loud environment. For example, this is known as the Lombard effect and can significantly change the way information is represented in a feature vector.

Perturbing the feature vector set in a skilled manner can replicate the types of conditions and processes associated with the variability of multiple spoken utterances. In particular, the changes due to speaker variability or environmental variability can be captured and applied to the feature vectors directly. Accordingly, a set of perturbations can be applied to the feature vector of a single spoken utterance which mimic the speaker's variability in pronouncing the spoken utterance numerous times. A set of perturbations can also be applied to the feature vector of a single spoken utterance which mimic the environmental variability. Notably, fewer spoken utterances are required as the perturbation provides an alternative means for artificially generating speaker or environmental variability in the spoken utterances.

For example, at step 206, randomly distributed noise can be added to the feature vector set for providing a perturbation. At step 208, the randomly distributed noise can be multiplied by a variance. At step 210, the variance can be multiplied by a scaling factor. Steps 206-210 can be applied in any order as the multiplication is an associative property. In addition, various other forms of perturbation such as filtering the feature vector in the time domain or frequency domain are herein contemplated. The perturbation can also be applied directly to the speech signal to model environmental or speaker effects. The multiplication by the variance establishes the bounds for the random noise; that is, the variance determines the statistical limits for which the feature vector is to be perturbed. In one arrangement, the variance can be applied uniformly across the feature vector. In another arrangement, the variance can be weighted across the feature vector. For example, the lower index cepstral coefficients generally have a higher natural variance than higher index cepstral coefficients. Cepstral coefficients are useful for separating out environmental conditions from speaker conditions. A cepstral average can model the effects of convolutive environmental noise. Accordingly, cepstral mean subtraction can also be used to de-convolve the environmental or speaker effects as another means of compensating for variability through perturbation.

At step 212, the perturbed feature vector set can be phonetically decoded for producing a perturbed phonetic string. A phonetic string is a sequence of symbolic characters representing phonemes of speech. Understandably, the feature vectors can correspond to phonemes which are the smallest units of sound. For example, referring to FIG. 3, the phonetic decoder 140 receives a feature vector and produces a phonetic string wherein phonetic characters of the phonetic string correspond to phonemes associated with a certain sequence of features in the feature vector. For example, a phoneme can be represented by a feature vector which is sufficiently unique to that phoneme. That is, there is a correspondence between the feature vector and the acoustic version of the phoneme which is consistent. For example, a feature vector consisting of 12 cepstral coefficients can be identified as a particular phoneme.

Method 200 recites steps for perturbing feature vectors for improving speech recognition performance. The steps of method 200 can be further applied to improving speech recognition performance for a speaker-dependent system using speaker-independent training models. In particular, a mobile device can include components of both a speaker-dependent system and a speaker-independent system. Combining aspects of both systems can allow a speaker-dependent system trained on only a few utterances to perform comparably to a speaker-dependent system trained on multiple utterances. In the context of a voice tag application, a user is often required to utter the same text 2-3 times in order to improve the speech recognition accuracy. However, in practice, the user would generally prefer to say the text only once. Accordingly, multiple phonetic voice tags can be created by perturbing feature vectors from a single spoken voice tag thereby reducing the number of utterances required from a user.

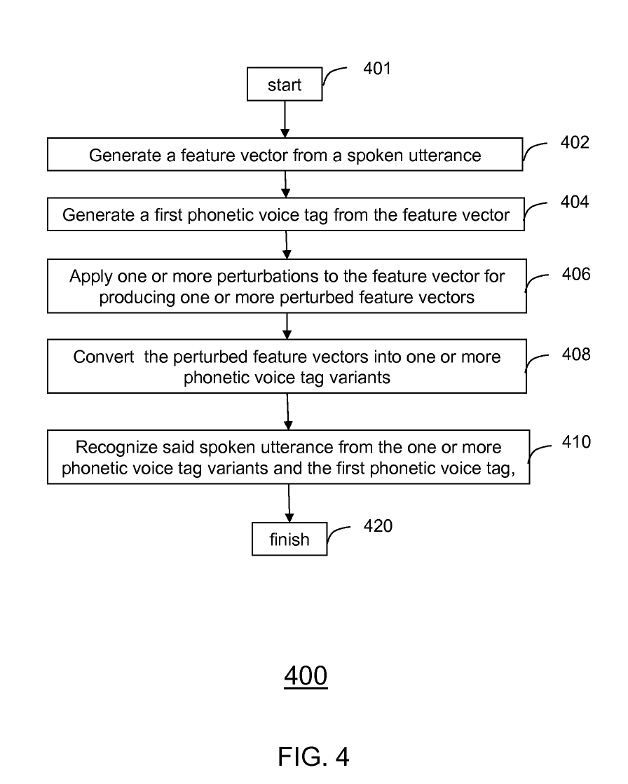

Referring to FIG. 4, a method 400 for perturbing a feature vector within the context of generating multiple phonetic voice tags. In particular, the perturbation is applied during voice-to-phone conversion in a speaker-independent mode of speech recognition. Reference will be made to FIGS. 1 and 2, which provide the methods and structural elements recited in FIG. 3.

At step 401, the method for producing phonetic voice tag variants in voice-to-phoneme conversion can begin. At step 402, a feature vector can be generated from a first spoken utterance. Referring to FIG. 3, the feature extractor 120 can generate a feature vector from the speech signal. For example the feature vector can be a set of cepstral coefficients. Cepstral coefficients, though statistically independent from one another, together perform a robust feature set; that is, they are immune to noise.

At step 404, a first phonetic voice tag can be generated from the feature vector. Notably, a phonetic voice tag of the original spoken voice tag can be generated for reference. Understandably, perturbation will be applied to this feature vector for producing multiple phonetic voice tag variants that can be saved with the reference phonetic voice tag. Referring to FIG. 3, the first feature vector can bypass the processor 130 as perturbation will not be applied to the first feature vector. Accordingly, the phonetic decoder 140 creates a phonetic string from the un-perturbed feature vector.

At step 406, one or more perturbations can be applied to the feature vector of step 404 for producing one or more perturbed feature vectors. Referring to FIG. 3, the processor 130 can perturb the feature vectors representing the spoken voice tag. For example, the feature vectors can be cepstral vectors and the processor 130 can determine a variance of the cepstral vectors. Cepstral coefficients, though statistically independent from one another, together perform a robust feature set; that is, they are good candidates for speech recognition. Cepstral coefficients can be modified (i.e. perturbed) to include modeling effects such as channel modeling, environmental modeling, and speaker modeling. The modification can include adding a variance weighted noise to account for environmental and speaker effects. In particular, a randomly distributed noise can be weighted by the variance and scaled by a scaling factor. The scaling factor can be between 0 and 1.0 which sets the bounds of the variance. Understandably, the perturbation adds controlled variability for producing multiple phonetic voice tag variants from a single spoken voice tag.

Referring to FIG. 3, the processor 130 can add controlled variability to the feature vector to produce a perturbed feature vector. For example, a change in environmental conditions can be modeled as a perturbation to the original environmental conditions. A change in a speaker's voice can be modeled as a perturbation to the original vocal characteristics. Understandably, the perturbation can be applied directly to the feature domain of the original feature vector for providing the same variability. Accordingly, a perturbation corresponding to an environmental condition or a speaker characteristic can be applied to a single spoken utterance for providing similar properties to replicating the variance of the environment or speaker.

Referring to the equation below, the feature vector X can be perturbed by a weighted random noise to produce a perturbed feature vector X′. The weighting is a result of the variance δ, and scaling factor, α. numeral value n,
X′=X+α·σ·random (−n,n)
where X={c₀ . . . c_{N}}

In the equation above, X represents a vector of features such as cepstral coefficients c₀ to c_{N}, where N defines the number of cepstral coefficients though the designation is not limited to cepstral terms. The feature vector X can also include the concatenation of various representations of cepstral coefficients including delta cepstral coefficients, and acceleration cepstral coefficients. The delta and cepstral coefficients are useful for capturing the first order dynamics of speech, and the cepstral acceleration coefficients are useful for capturing the temporal aspects of speech. In practice a feature vector can be produced from a short-time frame of speech. Each feature vector can consist of 12 Mel Frequency Cepstral Coefficients (MFCC), followed by twelve delta MFCCs, followed by 12 acceleration MFCCS. The feature vector can also include energy terms as well as other features uniquely describing characteristics of the short-time speech frame. The variance is defined by the δ term which can be a scalar multiplier to the vector of randomly distributed noise. The randomly distribute noise can be a vector of the same dimension as X. The scaling factor a sets the bounds of the variance.

The perturbed feature vector X′ can be submitted as input to the SRS for conversion to phoneme strings. In particular, the SRS can contain approximately 45 HMMs each specifically trained to recognize a particular phoneme from a feature vector. Each HMM can identify a particular phoneme from a feature vector. The HMMs can include a phoneme loop grammar for identifying a most likely phoneme candidate based on neighbor phonemes. For example, certain phonemes can have a high likelihood of being adjacent to other phonemes. The phoneme loop can identify the likelihood of a feature vector being associated to a particular phoneme based on the identified neighbor phonemes. The phoneme loop can include a search engine that uses context-independent (CI) and context-dependent (CD) sub-word and speaker-independent HMMs previously trained on a large speaker corpus. Notably, applying a perturbation based on a weighted variance of the feature vector effectively incorporates effects similarly received from changes in environmental conditions or changes in speaker characteristics. For example, a change in environmental conditions can be modeled as a perturbation to the original environmental conditions. A change in a speaker's voice can be modeled as a perturbation to the original vocal characteristics. Understandably, the perturbation can be applied directly to the feature domain of the original feature vector for providing the same variability. Accordingly, a perturbation corresponding to an environmental condition or a speaker characteristic can be applied to a single spoken utterance for providing replicating the variance of the environment or speaker.

At step 408, the perturbed feature vectors can be converted into one or more phonetic voice tag variants. Referring to FIG. 3, the phonetic decoder 140 can convert a feature vector to a phonetic vector. In one arrangement, the phonetic decoder 140 can include a plurality of Hidden Markov Models (HMMs) each specifically trained to recognize a phoneme from a feature vector, such as a cepstral coefficient vector. The HMMs can be trained to recognize phonemes from other feature vectors such as LPC, or Line Spectral Pair (LSP) coefficients. Alternatively the SRS can include a plurality of trained neural networks (NN) elements designed to recognize a phoneme from a feature vector. Embodiments of the invention are not herein limited to the SRS system used such as the HMM or the NN, though aspects of the invention are directed to perturbing the feature vector prior to phoneme recognition.

In practice, approximately 45 HMMs can be used to represent a set of phonemes typically expected to be encountered in natural language applications. The HMMs can be specifically trained to recognize a particular phoneme from a feature vector. The HMMs can be connected via a phoneme loop grammar engine for identifying a most likely phoneme candidate based on neighbor phonemes. For example, certain phonemes can have a high likelihood of being adjacent to other phonemes. The phoneme loop can identify the likelihood of a feature vector being associated to a particular phoneme based on the identified neighbor phonemes. The phoneme loop can include a search engine that uses context-independent (CI) and context-dependent (CD) sub-word and speaker-independent models previously trained on a large speaker corpus.

Notably, applying a perturbation based on a weighted variance of the feature vector effectively incorporates effects similarly received from changes in environmental conditions or changes in speaker characteristics. The HMMs are statistical models that inherently include flexibility in identifying phonemes from feature vectors. That is, perturbing the feature vectors can be considered a perturbation to the HMM system directly. Understandably, the perturbation applied to the feature vectors is a form of applying perturbation the HMM model. Accordingly, the HMM can be effectively perturbed in order to provide assurance that the feature vector submitted is within a bounds of discrimination. Notably, HMMs determine whether a feature vector falls within a class type, in this case, the class type is a phoneme category. The HMM does so by identifying whether properties of the feature vector fall within trained statistical bounds. Applying a perturbation tests whether the HMM will respond with the same output even though the input has been slightly modified (i.e. perturbed). HMMs exhibit a resiliency that can be used advantageously to assess whether the input has been accurately identified.

At step 410, a spoken utterance from one or more phonetic voice tag variants and the first phonetic voice tag can be recognized. For example, in a name dialing application, a user may speak the name of a person to call. The speech recognition system recognizes the name and automatically dials the call. Notably, methods 402-408 involve generating phonetic voice tag variants from a single spoken voice tag. The phonetic voice tag variants provide more phonetic voice tag examples for improving the accuracy of the speech recognition system. For example, a spoken utterance can be identified for each of the phonetic voice tag variants. For instance, a first phonetic voice tag variant may be generated by using a scaling factor α=0.5 and a second phonetic voice tag variant may be generated by using a scaling factor α=1.0. Accordingly, three phonetic voice tags are available; the original phonetic string, and the two phonetic variants. Notably, the speech recognition system can determine which spoken utterances match the three phonetic voice tags. If the speech recognition system returns the same response for all three phonetic voice tags, then a match is determined. Understandably, various scoring mechanisms can be included for determining a correct match and ultimately revealing the recognized spoken utterance.

In summary, a method for producing phonetic voice tag variants in voice-to-phoneme conversion has been shown for use in a speech recognition system. The method can be employed with speaker independent HMMs that are currently available in mobile communication devices. The speaker-independent HMMs can be used advantageously to reduce the number of phonetic voice tags required in speech recognition when a perturbation technique is applied prior to voice-to-phoneme conversion. For example, a name dialing application can recognize thousands of names downloaded from a phonebook and voice-tags. Accordingly, voice-tag entries and name entries with phonetic transcriptions are jointly used in a speaker-independent manner for name dialing speech recognition applications. Multiple phonetic voice tags can be generated by applying a perturbation to a feature vector prior to phoneme recognition. Perturbed feature vectors are converted to phoneme representations using already trained HMM speaker-independent models to increase a recognition performance.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A method for generating a perturbed phonetic string for use in speech recognition comprising:
generating a feature vector set from a spoken utterance;
applying a perturbation to said feature vector set for producing a perturbed feature vector set; and
phonetically decoding said perturbed feature vector set for producing a perturbed phonetic string,
wherein a phonetic string is a sequence of symbolic characters representing phonemes of speech.

2. The method of claim 1, wherein said applying a perturbation includes adding randomly distributed noise to said feature vector set.

3. The method of claim 2, further including multiplying said randomly distributed noise by a variance.

4. The method of claim 3, further including multiplying said variance by a scaling factor.

5. The method of claim 4, wherein said scaling factor is selected to correspond to an environmental condition during a recognition of said first phonetic voice tag.

6. The method of claim 4, wherein said feature vector set comprises Mel Frequency Cepstral Coefficients and said phonetic decoder comprises a plurality of trained speaker-independent Hidden Markov Models.

7. The method of claim 3, wherein said variance is a variance of said feature vector set.

8. The method of claim 3, wherein said variance is an acoustical variability of an environmental condition.

9. The method of claim 3, wherein said variance corresponds to a variability of a speaker producing said spoken utterance.

10. The method of claim 3, further comprising:
producing multiple recognition scores from said perturbed phonetic string; and
determining a confidence measure associated with said variance used in producing said perturbed phonetic string for training said speech recognition system.

11. A system for generating a perturbed phonetic string for use in speech recognition comprising:
a feature extractor for generating a feature vector set from a first phonetic voice tag;
a processor for applying a perturbation to said feature vector set for producing a perturbed feature vector set; and
a phonetic decoder for converting said perturbed feature vector set into a perturbed phonetic string,
wherein a phonetic string is a sequence of symbolic characters representing phonemes of speech.

12. The system of claim 11, wherein said processor adds randomly distributed noise to said feature vector set.

13. The method of claim 11, wherein said processor multiplies said randomly distributed noise by a variance.

14. The method of claim 13, wherein said processor multiplies said variance by a scaling factor.

15. The method of claim 13, wherein said variance is a variance of said feature vector set.

16. The method of claim 13, wherein said variance is an acoustical variability of an environmental condition.

17. The method of claim 13, wherein said variance corresponds to a variability of a speaker producing said spoken utterance.

18. The method of claim 14, wherein said scaling factor is selected to correspond to an environmental condition during a recognition of said first phonetic voice tag.

19. The method of claim 14, wherein said feature vector set comprises Mel Frequency Cepstral Coefficients and said phonetic decoder comprises a plurality of trained speaker-independent Hidden Markov Models.

20. A method for producing phonetic voice tag variants in voice-to-phoneme conversion comprising:
generating a feature vector from a first spoken utterance;
generating a first phonetic voice tag from said feature vector;
applying one or more perturbations to said feature vector for producing one or more perturbed feature vectors;
converting said perturbed feature vectors into one or more phonetic voice tag variants; and
recognizing a second spoken utterance from said one or more phonetic voice tag variants and said first phonetic voice tag,
wherein a phonetic voice tag is a string of symbolic characters representing phonemes of speech.

21. A method for producing phonetic voice tag examples for use in a speech recognition system comprising:
converting a spoken utterance to a plurality of feature vectors;
applying a perturbation to said feature vectors for producing a plurality of perturbed feature vectors; and
submitting said plurality of perturbed feature vectors to a plurality of speaker-independent Hidden Markov Models (HMMs) each trained to recognize a phoneme from a feature vector, said speaker-independent HMMs producing a concatenation of phonetic characters in a phonetic string;
wherein said speaker-independent HMMs are previously trained and include a phoneme loop grammar engine for identifying a most likely phoneme candidate based on neighbor phonemes, and a search engine that uses context-independent (CI) and context-dependent (CD) sub-word grammars.
